(19) United States
(12) Patent Application Publication
(10) Pub. No.: US 2025/0005852 A1
(43) Pub. Date: Jan. 2, 2025

(54) SEMANTIC MAP-ENABLED 3D MODEL CREATION USING NeRF

(71) Applicant: LENOVO (SINGAPORE) PTE. LTD., SINGAPORE (SG)

(72) Inventors: Song Wang, Morrisville, NC (US); Russell S. VanBlon, Morrisville, NC (US); Kevin W. Beck, Morrisville, NC (US); Mengnan Wang, Morrisville, NC (US)

(21) Appl. No.: 18/346,245

(22) Filed: Jul. 2, 2023

(51) Int. Cl. G06T 17/00; G06N 3/0475; G06T 7/70

(52) U.S. Cl. CPC G06T 17/00; G06N 3/0475; G06T 7/70; G06T 2207/20084; G06T 2207/30244

(57) ABSTRACT

In one aspect, a device includes a processor assembly and storage accessible to the processor assembly. The storage includes instructions executable by the processor assembly to access a semantic map and receive input from at least a first camera indicated in the semantic map. The instructions are also executable to use location data for the first camera as indicated in the semantic map, the input, and a neural radiance field (NeRF) neural network to generate a three-dimensional (3D) model of at least one object indicated in the semantic map.

### FIELD

The disclosure below relates to technically inventive, non-routine solutions that are necessarily rooted in computer technology and that produce concrete technical improvements. In particular, the disclosure below relates to semantic map-enabled 3D model creation using a neural radiance field (NeRF) neural network.

### BACKGROUND

As recognized herein, many three-dimensional (3D) model creation techniques are technically burdensome and very time consuming. They often involve very precise device knowledge of camera location, and in the process can consume undue amounts of power and processor resources while performing the camera location tracking. There are currently no adequate solutions to the foregoing computer-related, technological problem.

### SUMMARY

Accordingly, in one aspect a device includes a processor assembly and storage accessible to the processor assembly. The storage includes instructions executable by the processor assembly to access a semantic map and receive input from at least a first camera indicated in the semantic map. The instructions are also executable to use location data for the first camera as indicated in the semantic map, the input, and a neural radiance field (NeRF) neural network to generate a three-dimensional (3D) model of at least one object indicated in the semantic map.

In some specific example embodiments, the instructions may be executable to use location data for the at least one object as indicated in the semantic map to generate the 3D model of the at least one object. If desired, the instructions may even be executable to determine an angle from the first camera to the object based on the location data for the first camera and the location data for the object itself, and then use the angle as input to the NeRF neural network to generate the 3D model.

Additionally, in some example embodiments the input may be first input and the instructions may be executable to receive second input from a second camera indicated in the semantic map, where the second camera may be different from the first camera. Here the instructions may also be executable to use location data for the second camera as indicated in the semantic map and to use the second input to generate the 3D model of the at least one object via the NeRF neural network. If desired, the device may even include the first and second cameras. Also if desired, the instructions might be executable to use the NeRF neural network, the location data for the first and second cameras, and the first and second inputs to generate a 3D model of a scene of objects within a space, where the scene of objects may include the at least one object and where the scene of objects may be indicated in the semantic map.

In example implementations, the input from the first camera may include at least one two-dimensional (2D) image from the first camera.

Also in some example implementations, the instructions may be executable to determine that no people are present within a real-world space in which the at least one object is located. Based on the determination, the instructions may be executable to use the location data for the first camera as indicated in the semantic map, the input, and the NeRF neural network to generate the 3D model of the at least one object.

The device itself may include the first camera, if desired.

In another aspect, a method includes accessing a semantic map and receiving input from at least a first camera indicated in the semantic map. The method also includes using location data for the first camera as indicated in the semantic map, the input, and a neural radiance field (NeRF) neural network to generate a three-dimensional (3D) model of at least one object indicated in the semantic map.

In certain examples, the method may include using location data for the at least one object as indicated in the semantic map to generate the 3D model of the at least one object. Additionally, the method might specifically include determining an angle from the first camera to the object based on the location data for the first camera and the location data for the object, and then using the angle as input to the NeRF neural network to generate the 3D model.

Also, in some example implementations the input may be first input and the method may include receiving second input from a second camera indicated in the semantic map. The second camera may be different from the first camera. Here the method may also include using location data for the second camera as indicated in the semantic map and using the second input to generate the 3D model of the at least one object via the NeRF neural network.

In various example implementations, the input from the first camera may include at least one two-dimensional (2D) image from the first camera.

Also in various example implementations, the method may include determining that no people are present within a real-world space in which the at least one object is located. Based on the determination, the method may include using the location data for the first camera as indicated in the semantic map, the input, and the NeRF neural network to generate the 3D model of the at least one object.

In another aspect, at least one computer readable storage medium (CRSM) that is not a transitory signal includes instructions executable by a processor assembly to access a semantic map and to receive input from at least a first camera indicated in the semantic map. The instructions are also executable to use location data for the first camera as indicated in the semantic map, the input, and a neural radiance field (NeRF) neural network to generate a three-dimensional (3D) model of at least one object indicated in the semantic map.

In certain example implementations, the instructions may be executable to use location data for the at least one object as indicated in the semantic map to generate the 3D model of the at least one object. The instructions might even be executable to determine an angle from the first camera to the object based on the location data for the first camera and the location data for the object, and to use the angle as input to the NeRF neural network to generate the 3D model.

If desired, in some example embodiments the input may be first input and the instructions may be executable to receive second input from a second camera indicated in the semantic map, where the second camera may be different from the first camera. The instructions may also be executable to use location data for the second camera as indicated in the semantic map and to use the second input to generate the 3D model of the at least one object via the NeRF neural network.

Also in certain examples, the input from the first camera may include plural two-dimensional (2D) images from the first camera that are taken within a threshold time of each other.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is an illustration of an example real-world space that is semantically mapped consistent with present principles;

FIG. 3 shows an example graphical user interface (GUI) that may be used to select an object from the real-world space for which to create a 3D model using a semantic map and a NeRF neural network consistent with present principles;

FIG. 4 shows an example GUI that may be presented on a display when additional camera coverage would be useful for 3D model creation;

FIG. 5 illustrates example logic in example flow chart format that may be executed by a device consistent with present principles; and

FIG. 6 shows an example settings GUI that may be presented on a display to configure one or more settings of a device to operate consistent with present principles.

### DETAILED DESCRIPTION

Among other things, the detailed description below discusses using a semantic map to efficiently create a 3D model using a neural radiance field (NeRF) neural network, saving power and processor resources in at least some instances.

A NeRF neural network itself may represent and render realistic 3D scenes based on an input collection of 2D images. NeRF neural networks consistent with present principles may thus be configured to use inverse rendering and approximate how light behaves in the real world, enabling the NeRF neural network reconstruct a 3D scene from 2D images taken at different angles. The NeRF neural network may do so, for example, using a few dozen images taken from multiple positions around the scene, as well as using the camera position for each of those shots.

Semantic mapping technology may also be used consistent with present principles. Thus, semantic mapping may be used for a space, with object recognition capability in the map. Also note that an object in the map may have known coordinates for it indicated within the map. Accordingly, in one particular aspect, semantic mapping of a space may be accomplished through scanning via cameras to create a point cloud for various objects as well as 3D coordinates for the objects/points in the cloud themselves. Additionally, object recognition and/or other artificial intelligence (AI)-based systems can be used with the scanning process such that objects may be identified from a data training set as part of the scan and then labelled accordingly inside the space to achieve semantic understanding. Thus, the AI-enhanced map may not only create a 3D feature-rich map but also contain data like instances of objects recognized, their names, and their respective locations inside the mappable space. Utilizing semantic understanding, a device may thus identify precise location coordinates for various objects represented in the map.

Accordingly, in non-limiting examples, a semantic map may be generated using SLAM (and/or other mapping technologies for 3D electronic space mapping), where the SLAM map is enhanced with object recognition capability (e.g., object name/type tags) in the map to render a semantic map. Each recognized object in the semantic map may have known coordinates within the map, and the map may be searchable by object to locate the object within the map.

With the foregoing in mind, principles set forth further below discuss using both a NeRF neural network and a semantic map to autonomously capture images of a scene to generate 3D models of any object in the mappable space itself. This is because inside the semantic map, all objects (both recognized and unrecognized) may have known coordinates from semantic map generation. These objects may include devices with picture/video capture abilities, and they can be confirmed for use by the user through a UI/UX for security reasons if desired. If a user has a set of objects that he/she would like to create 3D models from, the map can determine if the connected devices with cameras inside the mappable space can capture enough angles to generate the dozen or so pictures that would be used to train the NeRF model to generate a 3D model of each object. These pictures can be taken simultaneously and/or in a relatively short time frame, with known camera angles to the object also being fed to the NeRF model from the semantic map.

Additionally, a designated user application may be used to allow the user to select/label and create 3D models of objects detected inside the semantically-mapped space. When the selected object does not have enough camera coverage, the user can be prompted to move any nearby camera-capable device(s) to create enough coverage of capture. The semantic map can also be updated in real time because of and responsive to device location changes (e.g., as detected based on input from motion sensors in the device itself, with the input indicating movement).

Additionally, other/all objects and the space inside the semantic map may be turned into a 3D model using this approach. All devices with cameras may thus work together to capture pictures needed to train the NeRF model over time, and as more coverage is needed for an object or area within the space, the user may be alerted to move any/all camera capable-devices to new locations based on the existing data captured. The process may be iterative and optimized to capture as many objects as possible in the space.

Accordingly, the 3D model content creation process can be improved by using sensor fusion of camera-capable devices in a semantic mapped space to allow optimal capture of pictures for training/deployment of the NeRF model.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino CA, Google Inc. of Mountain View, CA, or Microsoft Corp. of Redmond, WA. A Unix® or similar such as Linux® operating system may be used, as may a Chrome or Android or Windows or macOS operating system. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any single- or multi-chip processor that can execute logic by means of various lines such as address lines, data lines, and control lines and registers and shift registers. Moreover, any logical blocks, modules, and circuits described herein can be implemented or performed with a system processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may also be embodied in a non-transitory device that is being vended and/or provided, and that is not a transitory, propagating signal and/or a signal per se. For instance, the non-transitory device may be or include a hard disk drive, solid state drive, or CD ROM. Flash drives may also be used for storing the instructions. Additionally, the software code instructions may also be downloaded over the Internet (e.g., as part of an application (“app”) or software file). Accordingly, it is to be understood that although a software application for undertaking present principles may be vended with a device such as the system 100 described below, such an application may also be downloaded from a server to a device over a network such as the Internet. An application can also run on a server and associated presentations may be displayed through a browser (and/or through a dedicated companion app) on a client device in communication with the server.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library. Also, the user interfaces (UI)/graphical UIs described herein may be consolidated and/or expanded, and UI elements may be mixed and matched between UIs.

Logic when implemented in software, can be written in an appropriate language such as but not limited to hypertext markup language (HTML)-5, Java®/JavaScript, C# or C++, and can be stored on or transmitted from a computer-readable storage medium such as a hard disk drive (HDD) or solid state drive (SSD), a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as processors (e.g., special-purpose processors) programmed with instructions to perform those functions.

Present principles may employ machine learning models, including deep learning models. Machine learning models use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), recurrent neural network (RNN) which may be appropriate to learn information from a series of images, and a type of RNN known as a long short-term memory (LSTM) network. Support vector machines (SVM) and Bayesian networks also may be considered to be examples of machine learning models.

As understood herein, performing machine learning involves accessing and then training a model on training data to enable the model to process further data to make predictions. A neural network may include an input layer, an output/activation layer, and multiple hidden layers in between that have nodes configured and weighted to make inferences about an appropriate output.

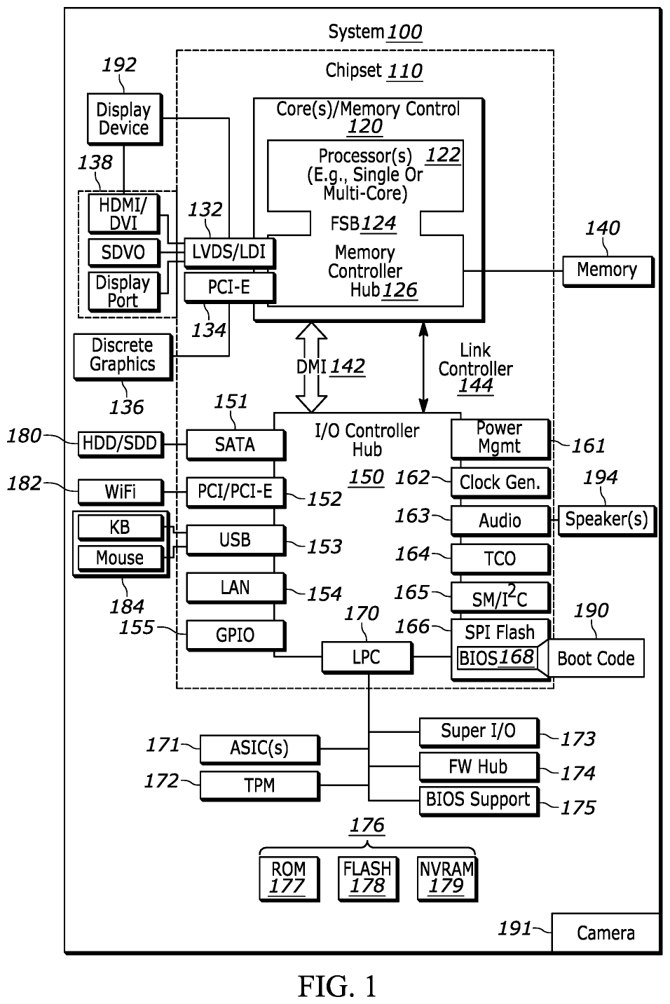

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, NC, or a workstation computer, such as the ThinkStation®, which are sold by Lenovo (US) Inc. of Morrisville, NC; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 includes a processor assembly 122 (e.g., one or more single core or multi-core processors, etc.) and a memory controller hub 126 that exchange information via a front side bus (FSB) 124. A processor assembly such as the assembly 122 may therefore include one or more processors acting independently or in concert with each other to execute an algorithm, whether those processors are in one device or more than one device. Additionally, as described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one or more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a local area network (LAN) interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface. Example network connections include Wi-Fi as well as wide-area networks (WANs) such as 4G and 5G cellular networks.

The interfaces of the I/O hub controller 150 may provide for communication with various devices, networks, etc. For example, where used, the SATA interface 151 and/or PCI-E interface 152 provide for reading, writing or reading and writing information on one or more drives 180 such as HDDs, SSDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

As also shown in FIG. 1, the system 100 may include a camera 191. The camera 191 may gather one or more images and provide the images and related input (e.g., metadata like an image timestamp) to the processor assembly 122. The camera may be a thermal imaging camera, an infrared (IR) camera, a digital camera such as a webcam, a three-dimensional (3D) camera, and/or a camera otherwise integrated into the system 100 and controllable by the processor assembly 122 to gather still images and/or video.

Additionally, though not shown for simplicity, in some embodiments the system 100 may include a gyroscope that senses and/or measures the orientation of the system 100 and provides related input to the processor assembly 122, an accelerometer that senses acceleration and/or movement of the system 100 and provides related input to the processor assembly 122, and/or a magnetometer that senses and/or measures directional movement of the system 100 and provides related input to the processor assembly 122. These three components may form part of an inertial measurement unit (IMU) in certain examples, where the IMU may be used in conjunction with one or more cameras (like the camera 191) to generate a three-dimensional (3D) point cloud and/or map of an area using simultaneous localization and mapping (SLAM) and/or other techniques consistent with present principles. Thus, coordinates for different objects and other 3D real-world features may be stored as part of the map. Object recognition may then be executed using the images to identify the names and/or object types for various objects recognized from the area via the camera input. The names and/or types may then be used as labels to label various objects shown in the point cloud/SLAM map to thus render a semantic map that indicates both 3D visual appearances and locations for the objects as well as tags corresponding to the labels identifying the objects.

Still further, the system 100 may include an audio receiver/microphone that provides input from the microphone to the processor assembly 122 based on audio that is detected, such as via a user providing audible input to the microphone. Also, the system 100 may include a global positioning system (GPS) transceiver that is configured to communicate with satellites to receive/identify geographic position information and provide the geographic position information to the processor assembly 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

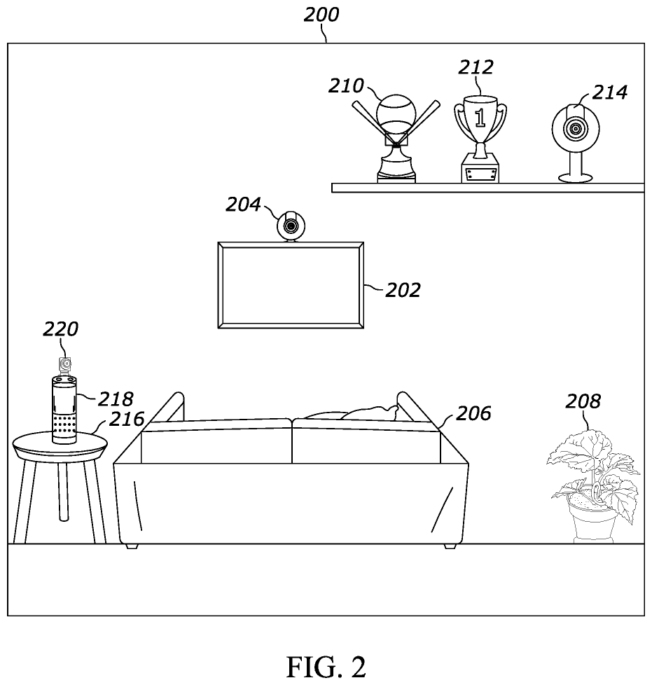

Turning now to FIG. 2, an example real-world area 200 is shown, which in this case is a living room of a personal residence. Shown in the area 200 are a television 202 with a built-in camera 204, a couch 206, a house plant 208, a baseball trophy 210, a first place trophy 212, and a stand-alone digital camera 214. The camera 214 may include a motor and rotation linkage to rotate 360 degrees in both the vertical and horizontal planes, if desired. Also shown is a coffee table 216 and a stand-alone digital assistant device 218 sitting on top of the table 216 (e.g., an Amazon Alexa device, Google Assistant, or a Lenovo Assistant device). Note that the device 218 may have its own camera 220.

Also note that the TV 202, camera 214, assistant device 218, and any other electronic smart devices in the area 200 may communicate over a network such as a Wi-Fi network, the Internet, a Bluetooth network, an ultra-wideband network, etc. in accordance with present principles. It is to also be understood that each of these devices may include at least some of the features, components, and/or elements of the system 100 described above. Indeed, any of the devices disclosed herein may include at least some of the features, components, and/or elements of the system 100 described above. Also note that these devices may communicate with an Internet-based cloud storage server accessible to the devices within the area 200 so that the devices in the area 200 can access a semantic map and/or other data described below as stored at the server, depending on implementation. The semantic map and/or other data may additionally or alternatively be stored at one of the devices 202, 214, 218, or other local device themselves.

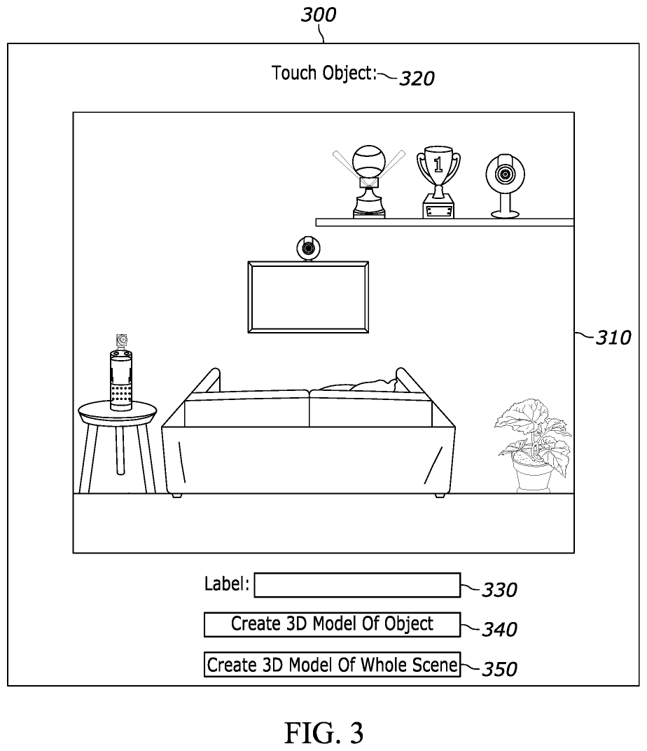

Now suppose a user wants to generate a 3D model of a given object within the area 200, or a 3D model of some or all of the area itself (including plural objects therewithin). The 3D model may be, in non-limiting examples, a computer graphics-based representation of exterior surfaces of an object in three dimensions and may include colors, textures, patterns, etc. of the object itself. To create such a 3D model, the user might open/launch a 3D modeling application (“app”) stored on his/her smartphone, headset, or other device. The app may then present the graphical user interface (GUI) 300 of FIG. 3 on a display of the user's device.

As shown in FIG. 3, an image/feed 310 of the area 200 is shown. The feed 310 may be a real-time live video feed of the area according to the field of view of one of the cameras in the area 200 as described above, if desired. The GUI 300 may also include a prompt 320 for the end-user to touch or otherwise select an object indicated in the feed 310 as presented on the GUI 300. Assume for this example that the user directs touch input to the baseball trophy 210 as presented on the display.

As also shown in this figure, the GUI 300 may include a text input field 330 that the user may select once the user has selected the desired object itself for which to create a 3D model. In some examples, the field 330 may be auto-populated with an object name and/or object type for the selected object as indicated in a semantic map of the area, with the auto-populated name/object type being determined from execution of object recognition during semantic map creation/update as described above. The user may then use a hard or soft keyboard to edit the object name/type if auto-populated, or to enter a name from scratch if not auto-populated. The name the user enters, or accepts as auto-populated, may then be used as the name of the 3D model that gets generated.

After a name has been entered into field 330, the user may select selector 340 to command the system to generate a 3D model of the trophy 210 using a semantic map and NeRF neural network consistent with present principles. Also note that, if desired, the user might instead select the selector 350 to create a 3D model of some or all of the area 200 itself, which may include not just the trophy 210 but other objects 202, 206, 208, 214, 216, and 218, if desired. In that case, the user might enter a different name into the field 330 to name the 3D model of the area itself.

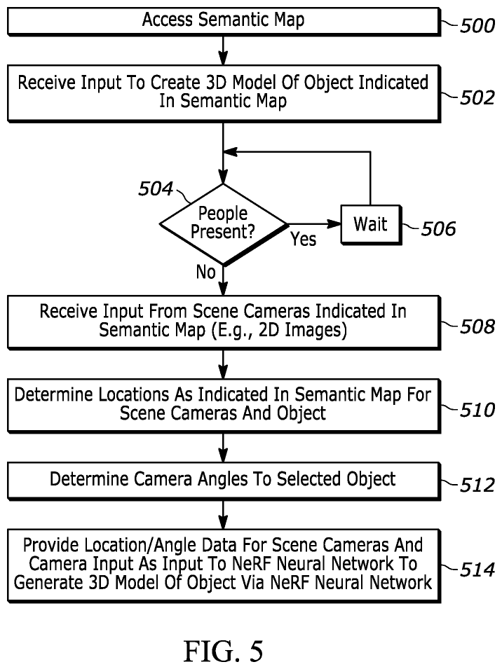

But assuming per this example that the user wishes to create a 3D model specifically of the trophy 210, the selector 340 may be selected to command the system to do so. The system may then use any and/or all cameras in the area 200 (including the cameras 204, 214, and 220) for which respective real-world location data is available via the semantic map for the area 200 (e.g., as already generated using SLAM and object recognition as described above). The system may then use respective input from each camera, along with the location data for the cameras and determined angles of view from the cameras toward the object 210, to generate a 3D model of the object 210 using the NeRF neural network. This process will be described in greater detail below in reference to FIG. 5.

But first, suppose a bottom right portion of the object 210 does not currently have adequate camera coverage via any of the cameras being used (bottom right being relative to the perspective shown in FIGS. 2 and 3). This might be due to no camera being positioned at an angle to adequately image that portion of the object 210, and/or due to another object occluding the object 210. For instance, the camera 214 may not be able to image the bottom right portion of the object 210 due to the object 212 obstructing that camera's view of that portion of the object 210.

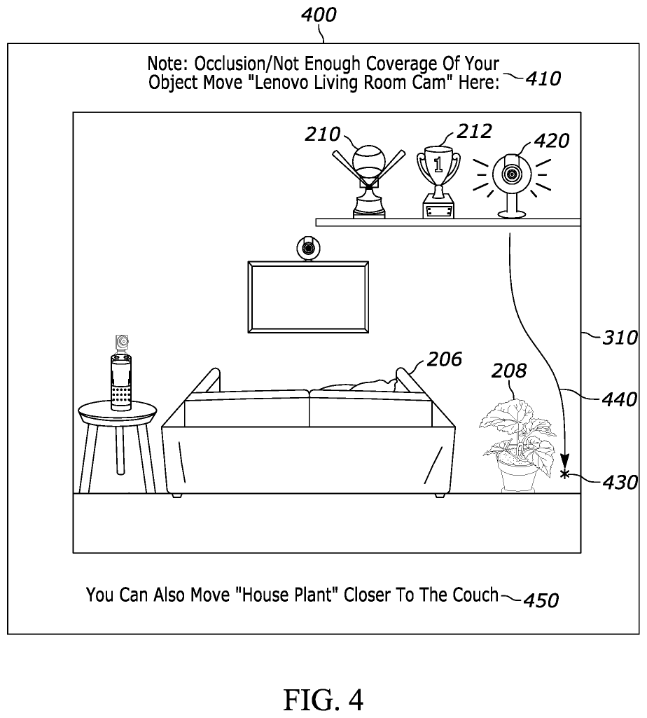

Responsive to a determination of inadequate camera coverage of a certain portion of the object 210, the system/app might try to change the field of view of the camera 214 itself using the motor and linkage described above in order to gain a better view of the inadequately covered area. Additionally or alternatively, but still responsive to the determination, the system/app may present the GUI 400 of FIG. 4.

As shown, the GUI 400 may include a prompt 410 that there exists an occlusion or otherwise inadequate camera coverage of part of the object 210 selected for 3D modeling. The prompt 410 may also instruct the end-user to move a camera that is highlighted via a halo effect graphic 420 to a real-world position within the area 200 as denoted by the asterisk 430 shown in the feed 310. The instruction may even include a user-designated or autonomously determined name for the specific camera for which movement is requested to help guide the user. A graphical arrow 440 may also be presented to help further guide the user for placement of the camera 214 at a location from which it may gain coverage of the otherwise occluded portion or missing coverage area for the object 210 itself. Once the camera 214 has been placed in the position indicated, the GUI 400 might also instruct the user to rotate the camera to a particular orientation in which the camera's field of view shows the area of the object for which additional coverage is being requested. Additionally or alternatively, the system/app may control the motor and linkage on the camera 214 itself to similarly reorient the camera toward the object 210 once placed at the location denoted by the graphic indicator/asterisk 430.

Also note that if the app/system determines that moving other objects about may also help with camera coverage of the object 210, a prompt 450 may be presented instructing the user to move the other object(s). Here, this includes an instruction to move the plant 208 closer to the couch 206 so that once the camera 214 is moved to the location denoted by the asterisk 430, its field of view has even greater coverage of the object 210.

Once the system/app has enough images of the object 210 for generation of the 3D model, the 3D model itself may then be generated. The flow chart of FIG. 5 further demonstrates this process.

Accordingly, now referring to FIG. 5, it shows example logic that may be executed by device such as the system 100 and/or processor assembly 122 consistent with present principles. The logic of FIG. 5 may therefore be executed by one or multiple devices (e.g., client device and remotely-located server) in any appropriate combination. Note that while the logic of FIG. 5 is shown in flow chart format, other suitable logic may also be used.

Beginning at block 500, the device may access/load a semantic map as stored locally and/or in remote cloud (server) storage or elsewhere. The logic may then proceed to block 502 where the device may receive input to create a 3D model of an object indicated in the semantic map. This input might be selection of the selector 340, for example.

From block 502 the logic may then proceed directly to block 508 or, in some examples, to decision diamond 504 first. At diamond 504, the device determine that no people are present within a real-world space in which the at least one object is located, which the user might configure in settings for the device/app should the user wish to not have images generated by area cameras while people are present for security and/or privacy reasons. This determination may be made using a human presence detection (HPD) algorithm and HPD sensors, using a camera and object recognition, etc. Responsive to an affirmative determination at diamond 504, the logic may proceed block 506 where the device may wait a threshold amount of time and then return to diamond 504 to make the determination again.

Then once a negative determination is made at diamond 504 (no people are present), the logic may proceed to block 508 where, based on the negative determination, the device may receive input from at least a first camera indicated in the semantic map. For instance, at block 508 the device may receive input from each camera in the scene/area that has at least a partial view of the object for which the 3D model is being created. And note here that the input that is received from each camera at block 508 may include plural two-dimensional (2D) images from each camera (e.g., images renderable in 2D on a flat screen display and generated using a single camera/image sensor even if showing the real-world in three dimensions) that are taken within a threshold time of each other for the NeRF to accurately generate the 3D model based on current lighting conditions. As such, the threshold time may be thirty seconds, for example.

From block 508 the logic may then proceed to block 510. At block 510 the device may determine the locations for the scene cameras and object being modeled, with the locations themselves being determined from the semantic map since the semantic map already has 3D location data (e.g., coordinates, whether expressed at GPS coordinates or in another type of coordinate system) for the cameras and object as determined when the semantic map itself was generated.

From block 510 the logic may then proceed to block 512. At block 512 the device may determine respective current angles of view from the cameras to the relevant object based on the location data for the cameras and the location data for the object itself (again, from the semantic map). For example, trigonometric equations may be used to determine the angles. Note that the angles of view may be determined for use by the NeRF neural network to generate the 3D model.

Thus, from block 512 the logic may proceed to block 514 where the device may provide the location data for the cameras and objects, as well as the corresponding angles of view, as input to the NeRF neural network. Also at block 514, the device may provide camera input (e.g., 2D images) from each of the cameras for which associated location data is provided so that the 3D model can be generated using the camera input. The device may then execute the NeRF neural network using the location data, angles, and camera input/images to generate a 3D model of the user's selected object.

Note that if the user chose to generate a 3D model of a scene of objects within a space, such as a 3D model of the entire area 200 as discussed above, the logic of FIG. 5 may be executed to generate a 3D model of the entire scene as well. The device might do so by generating a 3D model of the entire area without discriminating between objects. Additionally or alternatively, the device may do so by generating a 3D model of each object shown in the area, along with at least partial 3D models of other area features such as doors, windows, walls, and floors, and then assemble a larger 3D model to contain the 3D models of the individual objects and other area features. Either way, the device may generate the scene 3D model owing to precise location data for each object and feature already being stored and indicated in the semantic map itself.

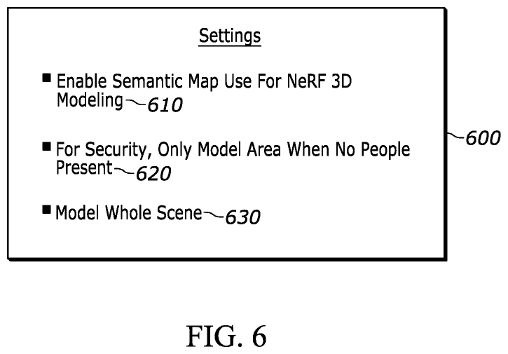

Continuing the detailed description in reference to FIG. 6, it shows an example settings GUI 600 that may be presented on the display of a device configured to undertake present principles (e.g., a device executing a semantic mapping/NeRF app consistent with present principles). The GUI 600 may be presented to set or enable one or more settings of the device/app, may might be navigated to through a device or app menu for example. Also note that each of the example options discussed below may be selected by directing touch or cursor input to the associated check box adjacent to the respective option.

As shown in FIG. 6, the GUI 600 includes an option 610 that may be selected to set or configure the device/app to undertake present principles. Thus, option 610 may be selected a single time to set or enable the device/app to, in multiple future instances, generate a 3D model from camera input and a semantic map using a NeRF neural network as described above (and/or to perform other functions described above with respect to the figures above). For instance, option 610 may be selected to command the device/app to perform the functions described above in reference to FIGS. 3 and 4 and to execute the logic of FIG. 5.

The GUI 600 may also include an option 620. The option 620 may be selectable to set the device/app to only generate and update 3D models of various objects or a whole scene when people are determined to not be present, providing enhanced digital security and privacy protections. Thus, selection of the option 620 may set the device/app to execute steps 504 and 506 of the logic of FIG. 5 rather than, e.g., the logic proceeding directly from block 502 to block 508.

Also if desired, the GUI 600 may include an option 630. The option 630 may be selected to command the device/app to generate a 3D model of an entire scene consistent with present principles. In certain specific examples, option 630 may be selected to command the device/app to initially generate a 3D model and then update the 3D model every day (or another recurring threshold period of time), even absent additional user input to do so such as input to the selector 350 described above. Accordingly, by using the option 630, an accurate and/or real-time 3D model of the scene may be accessed at will by the end-user.

It may now be appreciated that present principles provide for an improved computer-based user interface that increases the functionality and ease of use of the devices disclosed herein, minimizing power consumption and processor constraints in generating a 3D model with a NeRF neural network by using a semantic map as described above. The disclosed concepts are rooted in computer technology for computers to carry out their functions.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

What is claimed is:

1. A device, comprising:
a processor assembly; and
storage accessible to the processor assembly and comprising instructions executable by the processor assembly to:
access a semantic map;
receive input from at least a first camera indicated in the semantic map; and
use location data for the first camera as indicated in the semantic map, the input, and a neural radiance field (NeRF) neural network to generate a three-dimensional (3D) model of at least one object indicated in the semantic map.

2. The device of claim 1, wherein the instructions are executable to:
use location data for the at least one object as indicated in the semantic map to generate the 3D model of the at least one object.

3. The device of claim 2, wherein the instructions are executable to:
determine an angle from the first camera to the object based on the location data for the first camera and the location data for the object; and
use the angle as input to the NeRF neural network to generate the 3D model.

4. The device of claim 1, wherein the input is first input, and wherein the instructions are executable to:
receive second input from a second camera indicated in the semantic map, the second camera being different from the first camera; and
use location data for the second camera as indicated in the semantic map and use the second input to generate the 3D model of the at least one object via the NeRF neural network.

5. The device of claim 4, comprising the first and second cameras.

6. The device of claim 4, wherein the instructions are executable to:
use the NeRF neural network, the location data for the first and second cameras, and the first and second inputs to generate a 3D model of a scene of objects within a space, the scene of objects comprising the at least one object, the scene of objects indicated in the semantic map.

7. The device of claim 1, wherein the input from the first camera comprises at least one two-dimensional (2D) image from the first camera.

8. The device of claim 1, wherein the instructions are executable to:
determine that no people are present within a real-world space in which the at least one object is located; and
based on the determination, use the location data for the first camera as indicated in the semantic map, the input, and the NeRF neural network to generate the 3D model of the at least one object.

9. The device of claim 1, comprising the first camera.

10. A method, comprising:
accessing a semantic map;
receiving input from at least a first camera indicated in the semantic map; and
using location data for the first camera as indicated in the semantic map, the input, and a neural radiance field (NeRF) neural network to generate a three-dimensional (3D) model of at least one object indicated in the semantic map.

11. The method of claim 10, comprising:
using location data for the at least one object as indicated in the semantic map to generate the 3D model of the at least one object.

12. The method of claim 11, comprising:
determining an angle from the first camera to the object based on the location data for the first camera and the location data for the object; and
using the angle as input to the NeRF neural network to generate the 3D model.

13. The method of claim 10, wherein the input is first input, and wherein the method comprises:
receiving second input from a second camera indicated in the semantic map, the second camera being different from the first camera; and
using location data for the second camera as indicated in the semantic map and using the second input to generate the 3D model of the at least one object via the NeRF neural network.

14. The method of claim 10, wherein the input from the first camera comprises at least one two-dimensional (2D) image from the first camera.

15. The method of claim 10, comprising:
determining that no people are present within a real-world space in which the at least one object is located; and
based on the determination, using the location data for the first camera as indicated in the semantic map, the input, and the NeRF neural network to generate the 3D model of the at least one object.

16. At least one computer readable storage medium (CRSM) that is not a transitory signal, the at least one CRSM comprising instructions executable by a processor assembly to:
access a semantic map;
receive input from at least a first camera indicated in the semantic map; and
use location data for the first camera as indicated in the semantic map, the input, and a neural radiance field (NeRF) neural network to generate a three-dimensional (3D) model of at least one object indicated in the semantic map.

17. The CRSM of claim 17, wherein the instructions are executable to:
use location data for the at least one object as indicated in the semantic map to generate the 3D model of the at least one object.

18. The CRSM of claim 17, wherein the instructions are executable to:
determine an angle from the first camera to the object based on the location data for the first camera and the location data for the object; and
use the angle as input to the NeRF neural network to generate the 3D model.

19. The CRSM of claim 16, wherein the input is first input, and wherein the instructions are executable to:
receive second input from a second camera indicated in the semantic map, the second camera being different from the first camera; and
use location data for the second camera as indicated in the semantic map and use the second input to generate the 3D model of the at least one object via the NeRF neural network.

20. The CRSM of claim 16, wherein the input from the first camera comprises plural two-dimensional (2D) images from the first camera that are taken within a threshold time of each other.
